(19) United States
(12) Patent Application Publication
(10) Pub. No.: US 2022/0043181 A1
(43) Pub. Date: Feb. 10, 2022

(54) Public Utility Marker Assembly

(71) Applicant: Keith Kirsch, Cape May, NJ (US)

(72) Inventor: Keith Kirsch, Cape May, NJ (US)

(21) Appl. No.: 16/986,895

(22) Filed: Aug. 6, 2020

(51) Int. Cl. G01V 15/00; G09F 17/00

(52) U.S. Cl. CPC G01V 15/00; G09F 17/00

(57) ABSTRACT

A public utility marker assembly includes a water marker, a sewer marker, a gas maker, an electric marker and a communication marker that is each insertable into ground to mark the location of a respective an underground water line, underground sewer line, underground gas line, underground electric line or underground communication line. Each of the water marker, the sewer marker, the gas marker, the electric marker and the communication marker are comprised of a water soluble material. In this way each of the water marker, the sewer marker, the gas marker, the electric marker and the communication marker will decompose after a sufficient duration of time to protect the environment.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to marker devices and more particularly pertains to a new marker device for marking underground utilities prior to excavation activities.

### (2) Description of Related Art including information disclosed under 37 CFR 1.97 and 1.98.

The prior art relates to marker devices including a golf course sign that includes a stem and a panel for restricting access to an area on a golf course. The prior art discloses a marker that includes a rod that can be driven into the ground and a pliable sheet attached to the rod for displaying indicia for signage. The prior art discloses a marker stake that includes a ribbed spike and a flag attached thereto. The prior art discloses a survey marker that includes a rod and a head that insertably receives a survey flag. The prior art discloses a biodegradable marker stake that is fluorescent for marking a pathway in a darkened environment. The prior art further discloses a degradable stake that is insertable into the ground. The prior art discloses a surveyor's stake which includes a stake, a rod coupled to the stake and a flag coupled to the rod.

### BRIEF SUMMARY OF THE INVENTION

An embodiment of the disclosure meets the needs presented above by generally comprising a water marker, a sewer marker, a gas maker, an electric marker and a communication marker that is each insertable into ground to mark the location of a respective an underground water line, underground sewer line, underground gas line, underground electric line or underground communication line. Each of the water marker, the sewer marker, the gas marker, the electric marker and the communication marker are comprised of a water soluble material. In this way each of the water marker, the sewer marker, the gas marker, the electric marker and the communication marker will decompose after a sufficient duration of time to protect the environment.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a public utility marker assembly according to an embodiment of the disclosure.

FIG. 2 is a perspective view of a water marker of an embodiment of the disclosure.

FIG. 3 is a perspective view of a sewer marker of an embodiment of the disclosure.

FIG. 4 is a perspective view of gas marker of an embodiment of the disclosure.

FIG. 5 is a front view of an electric marker of embodiment of the disclosure.

FIG. 6 is a front view of an alternative embodiment of a gas marker of the disclosure.

FIG. 7 is a front view of communication marker of an embodiment of the disclosure.

### DETAILED DESCRIPTION OF THE INVENTION

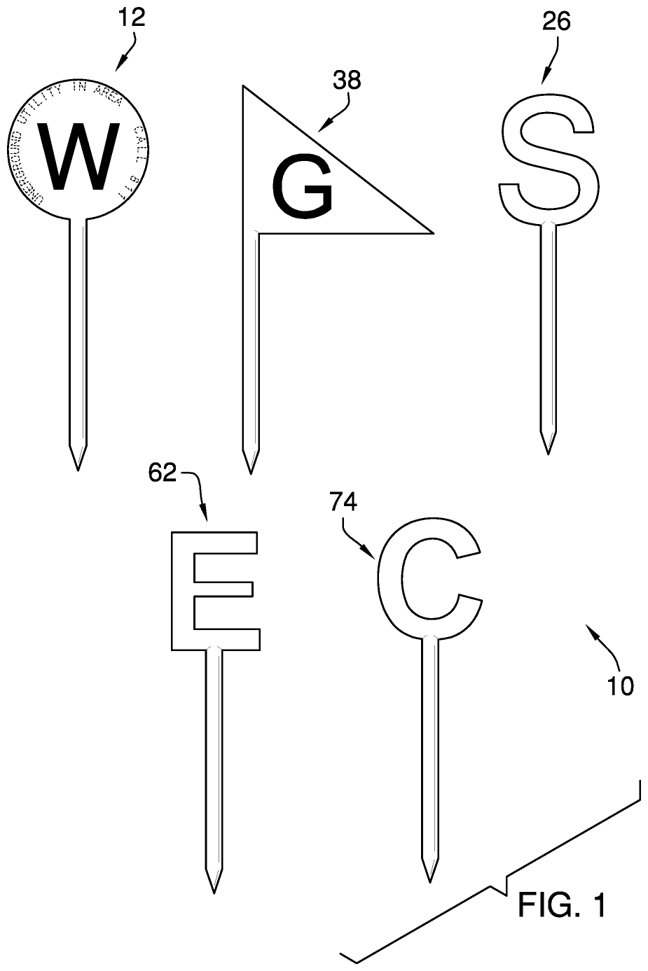

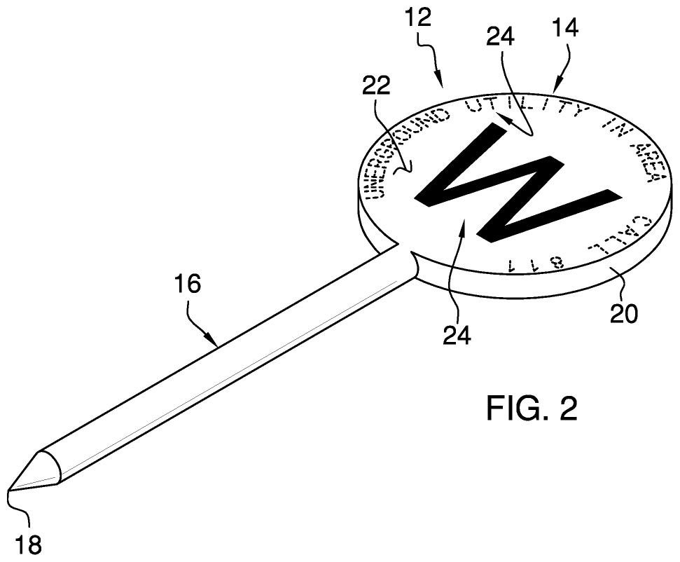

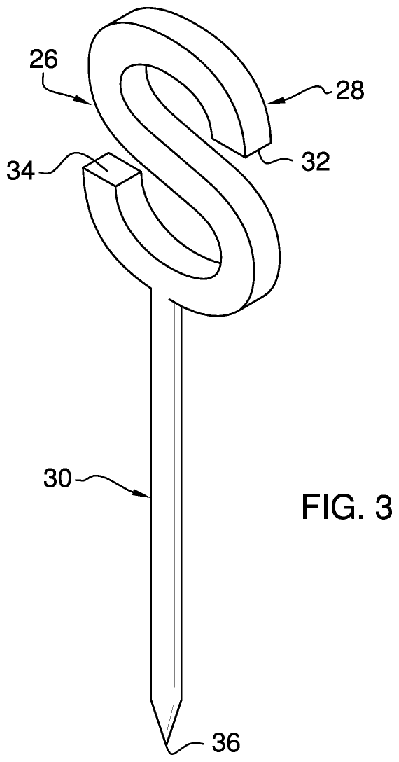

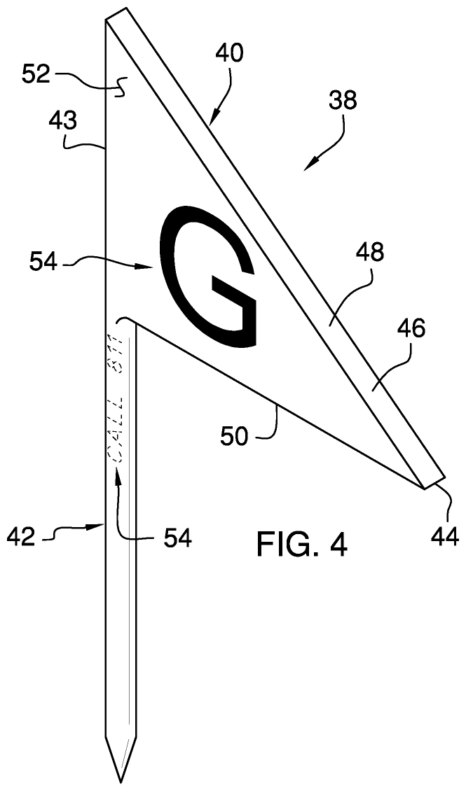

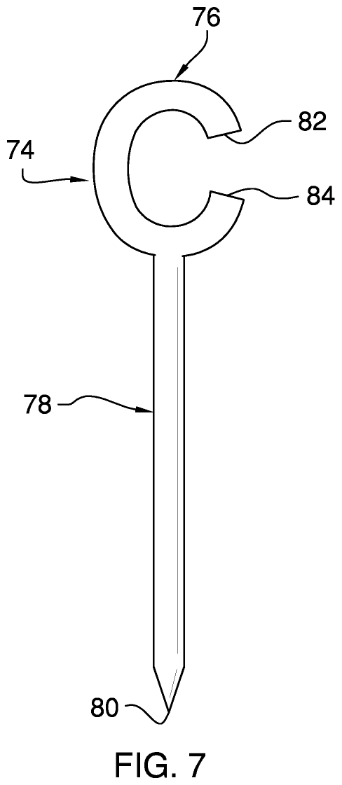

With reference now to the drawings, and in particular to FIGS. 1 through 7 thereof, a new marker device embodying the principles and concepts of an embodiment of the disclosure and generally designated by the reference numeral 10 will be described.

As best illustrated in FIGS. 1 through 7, the public utility marker assembly 10 generally comprises a water marker 12 that is insertable into ground to mark the location of an underground water line. The water marker 12 is comprised of a water soluble material including, but not being limited to, pressed paper, wood pulp or other suitable organic material. In this way the water marker 12 will decompose after a sufficient duration of time to protect the environment. The water marker 12 includes a head portion 14 and a stem portion 16 extending downwardly from the head portion 14. The stem portion 16 has a distal end 18 that tapers to a point for penetrating ground. The head portion 14 has a perimeter edge 20 and a front surface 22, and the perimeter edge 20 is continuously arcuate about a center point of the front surface 22 such that the head portion 14 has a disk shape. The front surface 22 has indicia 24 printed thereon comprising the letter “W” to indicate a water line. Additionally, the indicia 24 may comprise the words “underground utility in area” and “call 811”.

A sewer marker 26 is provided that is insertable into ground to mark the location of an underground sewer line. The sewer marker 26 is comprised of a water soluble material, including but not being limited to, pressed paper, wood pulp or other suitable organic material. In this way the sewer marker 26 will decompose after a sufficient duration of time to protect the environment. The sewer marker 26 includes an indicator portion 28 and a stem portion 30 extending downwardly from the indicator portion 28. The indicator portion 28 has a first end 32 and a second end 34, and the indicator portion 28 undulates between the first end 32 and the second end 34. Thus, the indicator portion 28 has the ornamental appearance of the letter “S” to indicate a sewer line. The stem portion 30 of the sewer marker 26 has a distal end 36 tapering to a point to penetrate the ground.

A gas marker 38 is provided that is insertable into ground to mark the location of an underground gas line. The gas marker 38 is comprised of a water soluble material, including but not being limited to, pressed paper, wood pulp or other suitable organic material. In this way the gas marker 38 will decompose after a sufficient duration of time to protect the environment. The gas marker 38 includes a head portion 40 and a stem portion 42 extending downwardly from the head portion 40 of the gas marker 38. The head portion 40 of the gas marker 38 has a first end 43, a second end 44 and a perimeter edge 46 extending therebetween. The perimeter edge 46 has a top side 48 and a bottom side 50, and the top side 48 and the bottom side 50 taper to a point at the second end 44 of head portion 40 of the gas marker 38. In this way the head portion 40 of the gas marker 38 has the ornamental appearance of a flag.

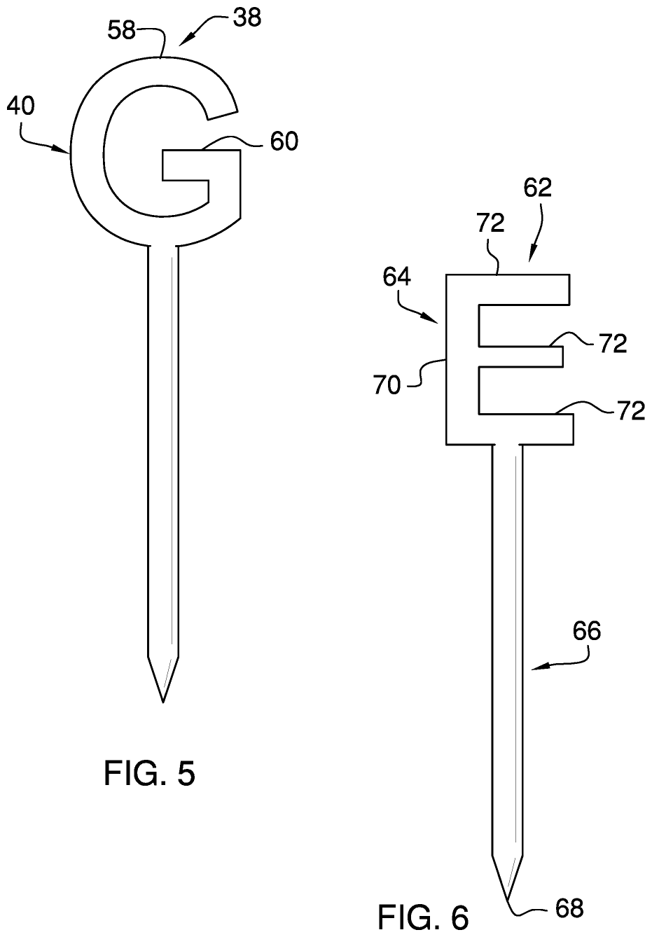

The head portion 40 of the gas marker 38 has a forward surface 52 and the forward surface 52 has indicia 54 printed thereon comprising the letter “G”. In this way the indicia 54 on the forward surface 52 indicate a gas line. The stem portion 42 of the gas marker 38 has a distal end 56 tapering to a point to penetrate the ground. The indicia 54 on the gas marker 38 may additionally include the words “call 811” extending downwardly along the stem portion 42 of the gas marker 38. As is most clearly seen in FIG. 5, the head portion 40 of the gas marker 38 may comprise a circular member 58 and an arm 60 extending toward a center point of the circular member 58. In this way the head portion 40 of the gas marker 38 may have the ornamental appearance of the letter “G” to indicate a gas line.

An electric marker 62 is provided and the electric marker 62 is insertable into ground to mark the location of an underground electric line. The electric marker 62 is comprised of a water soluble material, including but not being limited to, pressed paper, wood pulp or other suitable organic material. In this way the electric marker 62 will decompose after a sufficient duration of time to protect the environment. The electric marker 62 includes an indicator portion 64 and a stem portion 66 extending downwardly from the indicator portion 64 of the electric marker 62. The stem portion 66 of the electric marker 62 has a distal end 68 tapering to a point to penetrate the ground. The indicator portion 64 of the electric marker 62 includes a first arm 70 that is vertically oriented and a plurality of second arms 72 that is each perpendicularly oriented to the first arm 70. Thus, the indicator portion 64 of the electric marker 62 has the ornamental appearance of the letter “E” to indicate an electric line.

A communication marker 74 is provided that is insertable into ground to mark the location of an underground communication line. The communication marker 74 is comprised of a water soluble material, including but not being limited to, pressed paper, wood pulp or other suitable organic material. In this way the communication marker 74 will decay after a sufficient duration of time to protect the environment. The communication marker 74 includes an indicator portion 76 and a stem portion 78 extending downwardly from the indicator portion 76 of the communication marker 74. The stem portion 78 of the communication marker 74 has a distal end 80 tapering to a point to penetrate the ground.

The indicator portion 76 of the communication marker 74 has a primary end 82 and a secondary end 84. The indicator portion 76 of the communication marker 74 is curved between the primary end 82 and the secondary end 84. Additionally, the primary end 82 is aligned with and is spaced from the secondary end 84. In this way the indicator portion 76 of the communication marker 74 has the ornamental appearance of the letter “C” to indicate a communication line.

In use, the water marker 12, the gas marker 38, the electric marker 62, the sewer marker 26 or the communication marker 74 is inserted into the ground to mark the location of a respective underground water line, an underground gas line, an underground electric line, an underground sewer line or an underground communication line. In this way the location of the underground water line, the underground gas line, the underground electric line, the underground sewer line or the underground communication line is indicated prior to the commencement of excavation activities. The water marker 12, the gas marker 38, the electric marker 62, the sewer marker 26 or the communication marker 74 decays after a suitable duration of time to protect the environment. In this way the process of marking underground utilities is improved compared to existing utility marker flags that are frequently washed into gutters and sewer lines to ultimately be washed into rivers and oceans.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A public utility marker assembly for marking locations of underground public utilities prior to excavation activities, said assembly comprising:
a water marker being insertable into ground wherein said water marker is configured to mark the location of an underground water line, said water marker being comprised of a water soluble material wherein said water marker is configured to decompose after a sufficient duration of time to protect the environment;
a sewer marker being insertable into ground wherein said sewer marker is configured to mark the location of an underground sewer line, said sewer marker being comprised of a water soluble material wherein said sewer marker is configured to decompose after a sufficient duration of time to protect the environment;
a gas marker being insertable into ground wherein said gas marker is configured to mark the location of an underground gas line, said gas marker being comprised of a water soluble material wherein said gas marker is configured to decompose after a sufficient duration of time to protect the environment;
an electric marker being insertable into ground wherein said electric marker is configured to mark the location of an underground electric line, said electric marker being comprised of a water soluble material wherein said electric marker is configured to decompose after a sufficient duration of time to protect the environment; and
a communication marker being insertable into ground wherein said communication marker is configured to mark the location of an underground communication line, said communication marker being comprised of a water soluble material wherein said communication marker is configured to decay after a sufficient duration of time to protect the environment.

2. The assembly according to claim 1, wherein said water marker includes a head portion and a stem portion extending downwardly from said head portion, said stem having a distal end tapering to a point wherein said stem is configured to penetrate ground.

3. The assembly according to claim 2, wherein said head portion has a perimeter edge and a front surface, said perimeter edge being continuously arcuate about a center point of said front surface such that said head portion has a disk shape, said front surface having indicia being printed thereon comprising the letter “W” wherein said indicia are configured to indicate a water line.

4. The assembly according to claim 1, wherein said sewer marker includes an indicator portion and a stem portion extending downwardly from said indicator portion, said stem portion of said sewer marker has a distal end tapering to a point wherein said stem of said sewer marker is configured to penetrate the ground.

5. The assembly according to claim 4, wherein said indicator portion has a first end and a second end, said indicator portion undulating between said first end and said second end such that said indicator portion has the ornamental appearance of the letter “S” wherein said indicator portion is configured to indicate a sewer line.

6. The assembly according to claim 1, wherein said gas marker includes a head portion and a stem portion extending downwardly from said head portion of said gas marker, said stem portion of said gas marker having a distal end tapering to a point wherein said stem of said gas marker is configured to penetrate the ground.

7. The assembly according to claim 6, wherein said head portion of said gas marker has a first end, a second end, and perimeter edge extending therebetween, said perimeter edge having a top side and a bottom side, said top side and said bottom side tapering to a point at said second end of head portion of said gas marker such that said head potion of said gas marker has the ornamental appearance of a flag.

8. The assembly according to claim 6, wherein said head portion of said gas marker has a forward surface, said forward surface having indicia being printed thereon comprising the letter “G” wherein said indicia on said forward surface are configured to indicate a gas line.

9. The assembly according to claim 1, wherein said electric marker includes an indicator portion and a stem portion extending downwardly from said indicator portion of said electric marker, said stem portion of said electric marker having a distal end tapering to a point wherein said stem of said electric marker is configured to penetrate the ground.

10. The assembly according to claim 9, wherein said indicator portion of said electric marker includes a first arm being vertically oriented and a plurality of second arms each being perpendicularly oriented to said first arm such that said indicator portion of said electric marker has the ornamental appearance of the letter “E” wherein said indicator portion of said electric marker is configured to indicate an electric line.

11. The assembly according to claim 1, wherein said communication marker includes an indicator portion and a stem portion extending downwardly from said indicator portion of said communication marker, said stem portion of said communication marker having a distal end tapering to a point wherein said stem portion of said communication marker is configured to penetrate the ground.

12. The assembly according to claim 11, wherein said indicator portion of said communication marker having a primary end and a secondary end, said indicator portion of said communication marker being curved between said primary end and said secondary end, said primary end being aligned with and being spaced from said secondary end such that said indicator portion of said communication marker has the ornamental appearance of the letter “C” wherein said indicator portion of said communication marker is configured to indicate a communication line.

13. A public utility marker assembly for marking locations of underground public utilities prior to excavation activities, said assembly comprising:
a water marker being insertable into ground wherein said water marker is configured to mark the location of an underground water line, said water marker being comprised of a water soluble material wherein said water marker is configured to decompose after a sufficient duration of time to protect the environment, said water marker including a head portion and a stem portion extending downwardly from said head portion, said stem having a distal end tapering to a point wherein said stem is configured to penetrate ground, said head portion having a perimeter edge and a front surface, said perimeter edge being continuously arcuate about a center point of said front surface such that said head portion has a disk shape, said front surface having indicia being printed thereon comprising the letter “W” wherein said indicia are configured to indicate a water line;
a sewer marker being insertable into ground wherein said sewer marker is configured to mark the location of an underground sewer line, said sewer marker being comprised of a water soluble material wherein said sewer marker is configured to decompose after a sufficient duration of time to protect the environment, said sewer marker including an indicator portion and a stem portion extending downwardly from said indicator portion, said indicator portion having a first end and a second end, said indicator portion undulating between said first end and said second end such that said indicator portion has the ornamental appearance of the letter “S” wherein said indicator portion is configured to indicate a sewer line, said stem portion of said sewer marker having a distal end tapering to a point wherein said stem of said sewer marker is configured to penetrate the ground;
a gas marker being insertable into ground wherein said gas marker is configured to mark the location of an underground gas line, said gas marker being comprised of a water soluble material wherein said gas marker is configured to decompose after a sufficient duration of time to protect the environment, said gas marker including a head portion and a stem portion extending downwardly from said head portion of said gas marker, said head portion of said gas marker having a first end, a second end, and perimeter edge extending therebetween, said perimeter edge having a top side and a bottom side, said top side and said bottom side tapering to a point at said second end of head portion of said gas marker such that said head potion of said gas marker has the ornamental appearance of a flag, said head portion of said gas marker having a forward surface, said forward surface having indicia being printed thereon comprising the letter “G” wherein said indicia on said forward surface are configured to indicate a gas line, said stem portion of said gas marker having a distal end tapering to a point wherein said stem of said gas marker is configured to penetrate the ground;
an electric marker being insertable into ground wherein said electric marker is configured to mark the location of an underground electric line, said electric marker being comprised of a water soluble material wherein said electric marker is configured to decompose after a sufficient duration of time to protect the environment, said electric marker including an indicator portion and a stem portion extending downwardly from said indicator portion of said electric marker, said stem portion of said electric marker having a distal end tapering to a point wherein said stem of said electric marker is configured to penetrate the ground, said indicator portion of said electric marker including a first arm being vertically oriented and a plurality of second arms each being perpendicularly oriented to said first arm such that said indicator portion of said electric marker has the ornamental appearance of the letter “E” wherein said indicator portion of said electric marker is configured to indicate an electric line; and
a communication marker being insertable into ground wherein said communication marker is configured to mark the location of an underground communication line, said communication marker being comprised of a water soluble material wherein said communication marker is configured to decay after a sufficient duration of time to protect the environment, said communication marker including an indicator portion and a stem portion extending downwardly from said indicator portion of said communication marker, said stem portion of said communication marker having a distal end tapering to a point wherein said stem portion of said communication marker is configured to penetrate the ground, said indicator portion of said communication marker having a primary end and a secondary end, said indicator portion of said communication marker being curved between said primary end and said secondary end, said primary end being aligned with and being spaced from said secondary end such that said indicator portion of said communication marker has the ornamental appearance of the letter “C” wherein said indicator portion of said communication marker is configured to indicate a communication line.
